(19) United States
(12) Patent Application Publication
(10) Pub. No.: US 2005/0259415 A1
(43) Pub. Date: Nov. 24, 2005

(54) Lighted sign fixture having reflective surface

(76) Inventor: Hae-Ryong Jung, Arlington, VA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,131

(22) Filed: Jan. 11, 2005

Related U.S. Application Data
(60) Provisional application No. 60/542,877, filed on May 19, 2004.

(51) Int. Cl. F21S 8/00

(52) U.S. Cl. 362/227

(57) ABSTRACT

A lighting system (1) is provided which generally comprises a fixture body assembly (10); a face assembly (5) coupled to the fixture body assembly (10) to extend at least partially over a channel (15) defined thereby; a flexible reflective member (20) disposed in the channel (15) formed by the fixture body assembly (10) to define a reflective surface; and, a light source (60) disposed adjacent a base portion of the reflective surface. The fixture body assembly (10) includes a longitudinally extended inside base surface (14) and at least a pair of laterally opposed inner side surfaces (13) transversely oriented relative to the inside base surface (14), such that the inner side and inside base surfaces define the longitudinally extended channel (15). The face assembly (5) extends at least partially over the channel (15), and includes a light transmissive portion (72). The reflective member (20) is defectively retained by the face and fixture body assemblies (5, 10) to define a reflective surface concavely arcuate in sectional contour, with the base portion of its reflective surface being supported by the fixture body assembly's inside base surface (14). The light emitted by the light source (60) in this system (1) is directed in a substantially wide angle illumination pattern through the light transmissive portion (72) of the face assembly (5).

### RELATED U.S. APPLICATION DATA

This application is a Continuation-In-Part of a co-pending U.S. patent application Ser. No. ______, entitled “LIGHTED SIGN FIXTURE HAVING REFLECTIVE SURFACE,” being filed concurrently with this application.

### BACKGROUND OF THE INVENTION

1. Field of the Invention

The subject lighted sign fixture having reflective surface is generally directed to a lighting system capable of maintaining a bright wide angle illumination pattern through a light transmissive portion of a given sign. More specifically, the lighted sign fixture is one whose simple structure permits easy and convenient assembly while maintaining a quadratic curvature in its reflective surface. The lighted sign for the fixture provides a simple retentive structure for maintaining a flexible reflective member in this manner.

2. Prior Art

Lamp lighting systems are known in the art, as are lighted sign fixtures having reflective surfaces. One such lighting system is disclosed in U.S. Pat. No. 5,509,223, issued Apr. 23, 1996 to Applicant. The lighting system disclosed in that Patent is highly effective in providing a substantially constant illumination density for a brightly visible emission of light through a sign member. For ease and economy of manufacture, as well as for optimum reconfigurability and serviceability in the field, there is still a need for a simpler lighting fixture which provides such structural advantages while preserving the brightness of sign illumination.

The proper contour must be preserved for the lamp system's reflective surface if the proper illumination effect is to be generated and consistently maintained. In known lighting systems, the reflective member is formed of a material pre-formed with the required surface contour. Alternatively, the reflective surface is formed by a coating or other laminate applied to a rigid backing having such pre-formed contour. The need to pre-form and/or pre assemble the reflective surface contour in each of these cases not only burdens manufacturability and cost, the fixed nature of the structural components impedes the ready maintenance and repair of such lighting fixture.

Hence, there remains a need in the art for a lighting system wherein the arcuate reflective surface contour required for a given application may be conveniently and quickly realized, even without the need for pre-shaping, pre-forming, or pre-assembly of reflective surface components.

### SUMMARY OF THE INVENTION

It is, therefore, an object of the present invention to provide a lighting system capable of generating a brightly visible emission of light through a sign member.

It is another object of the present invention to provide a lighting system wherein an arcuate reflective surface contour is conveniently and quickly realized in a simple and easily manufactured fixture.

These and other objects are attained in a lighting system formed in accordance with the present invention. The subject lighting system generally comprises a fixture body assembly; a face assembly coupled to the fixture body assembly to extend at least partially over a channel defined thereby; at least one wing bone member disposed in the channel; a plurality of flexible reflective members disposed in the channel to define respective reflective surfaces; and, at least a pair of light sources each disposed adjacent a base portion of one reflective surface. The fixture body assembly includes a longitudinally extended inside base surface and at least a pair of laterally opposed inner side surfaces transversely oriented relative to the inside base surface, such that the inner side and inside base surfaces define the longitudinally extended channel. The face assembly extends at least partially over the channel, and includes a light transmissive portion. Each wing bone member is formed with a pair of cupped surfaces extending arcuately downward from opposing sides of an apex portion. At least a first and a second of the reflective members each being defectively retained between one cupped surface of a wing bone member and one inner side surface of the fixture body assembly to define a concave reflective surface substantially semi-circular in sectional contour. The light collectively emitted by the light sources is directed in a substantially wide angle illumination pattern through the light transmissive portion of the face assembly.

### BRIEF DESCRIPTION OF THE DRAWINGS

FIG. 1 is a perspective view of a fixture body assembly in one exemplary embodiment of the present invention;

FIG. 2 is a perspective view of the fixture body assembly shown with a flexible reflective member disposed therein, in accordance with the exemplary embodiment of the present invention;

FIG. 3 is an exploded perspective view of the fixture body assembly with the flexible reflective member disposed therein, illustrating the attachment of end plate members, in accordance with the exemplary embodiment of the present invention;

FIG. 4(a) is a schematic sectional view of a lighting system assembled in accordance with the exemplary embodiment of the present invention;

FIG. 4(b) is a perspective view of a face panel member formed in accordance with the exemplary embodiment of the present invention;

FIG. 4(c) is a perspective view of the lighting system assembled in accordance with the exemplary embodiment of the present invention, shown with the face panel member of FIG. 4(b) removed;

FIG. 5 is a schematic elevational view, partially cut away, of a portion of a lighting system formed in accordance with another exemplary embodiment of the present invention;

FIG. 6 is a perspective view, partially cut away, of another portion of the lighting system formed in accordance with the exemplary embodiment of the present invention shown in FIG. 5;

FIG. 7(a) is a schematic sectional view, partially cut away, of a portion of the lighting system formed in accordance with the exemplary embodiment of the present invention shown in FIG. 5;

FIG. 7(b) is a schematic sectional view, partially cut away, of a slightly modified configuration of the portion of the lighting system embodiment shown in FIG. 7(a);

FIG. 8 is an enlarged schematic elevational view of a portion of the lighting system formed in accordance with the exemplary embodiment of the present invention shown in FIG. 5; and,

FIG. 9 is an expanded schematic elevational view of a portion of the embodiment of the lighting system as shown in FIG. 5.

### DETAILED DESCRIPTION OF THE PREFERRED EMBODIMENTS

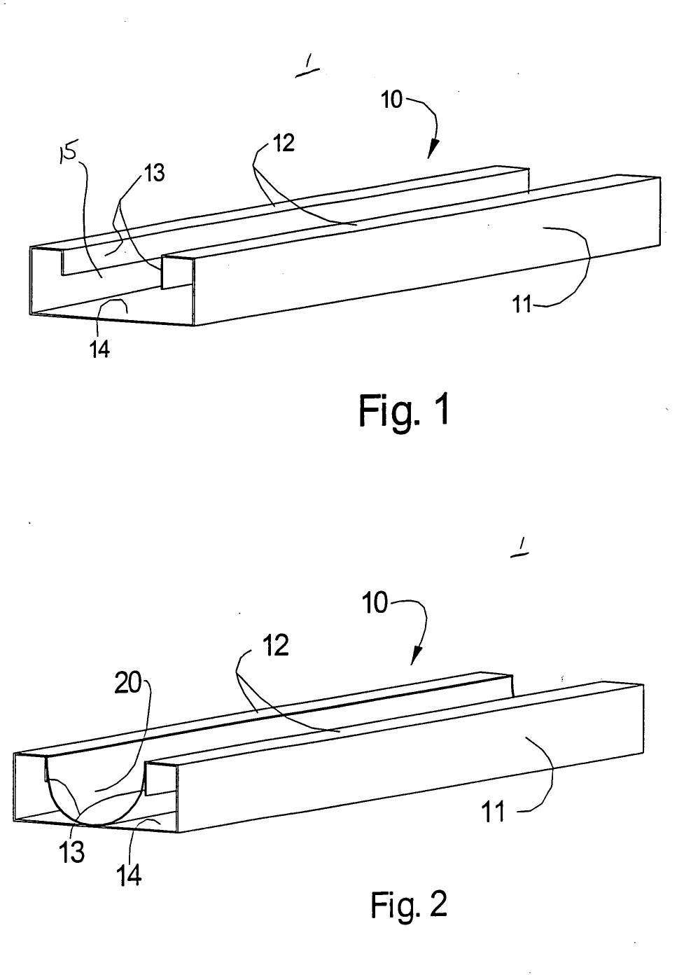

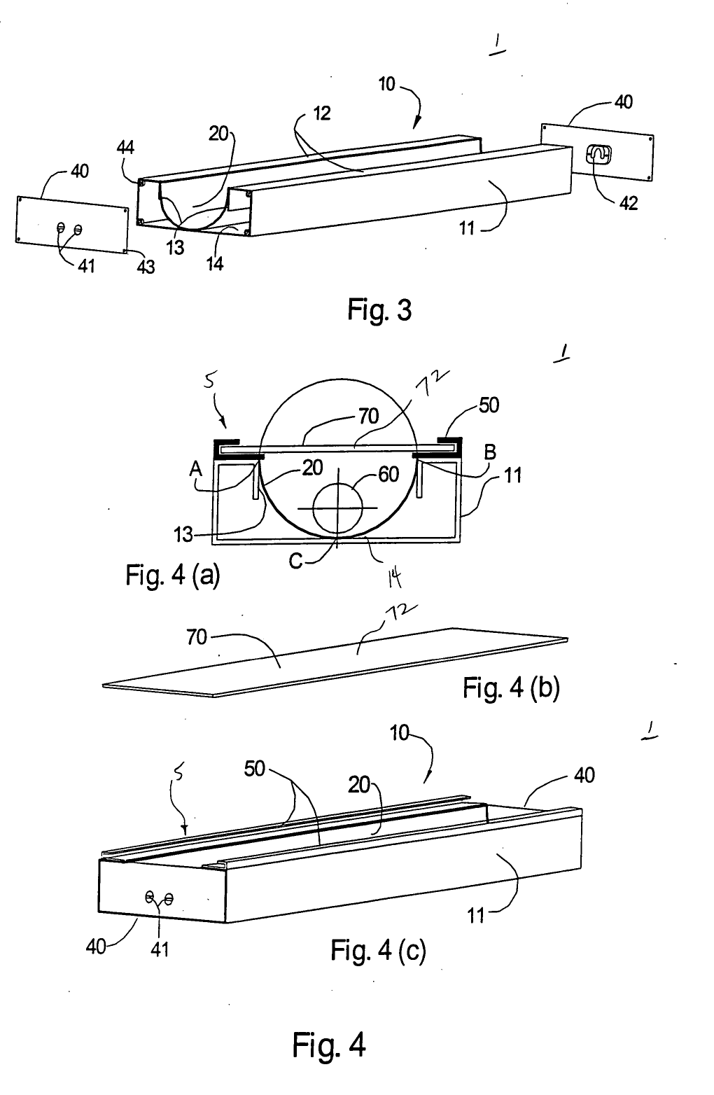

Referring now to FIGS. 1-4(c), there is illustrated a lighting system 1 formed in accordance with an exemplary embodiment of the present invention. In this exemplary embodiment, lighting system 1 generally includes a fixture body assembly 10 and a face assembly 5 coupled thereto. Fixture body and face assemblies 10, 5 together house a light source 60 and retain a flexible reflective member 20 at a predetermined arcuate configuration thereabout. In accordance with one aspect of the present invention, flexible reflective member 20 need not itself be pre-shaped or otherwise pre-configured with the predetermined curvature in its reflective surface contour necessary for generating the desired illumination effect. Flexible reflective member 20 need only be of sufficient flexibility to form the necessary curvature when it is slid or otherwise inserted within fixture body assembly 10.

The retaining structure defined by fixture body assembly 10, preferably in combination with face assembly 5, serve to deflect flexible reflective member 20 in the degree required for proper shaping of its reflective surface. The predetermined curvature is thus imparted to flexible reflective member 20 by virtue of its retention within fixture body assembly 10, when lighting system 1 is fully assembled.

As shown in the isolated perspective view of FIG. 1, fixture body assembly 10 is integrally formed in the exemplary embodiment disclosed with an inside bottom, or base, surface 14 from which a pair of outside surface-forming side walls 11 extend transversely upward. A top surface 12 laterally extends from the upper periphery of each side wall 11 to form a shelf- or shoulder-like portion. A pair of inner side surfaces 13 then extend respectively downward from the inner lateral peripheries of these top surfaces 12 to define—along with the inside base surface 14—a longitudinally extended channel 15. It is this channel 15 which receives to extend longitudinally therein both flexible reflective member 20 and light source 60.

Inner side surfaces 13 and inside base surface 14 cooperatively define channel 15. Their relative configurations—in terms of position, orientation, contour, dimension, and the like—then determine the corresponding configuration of channel 15. Hence, the relative configurations of these surfaces 13, 14 effectively define the contour realized for the flexible reflective member's reflective surface. In the exemplary embodiment shown, for instance, the relative configurations of inner side surfaces 13 and base surface 14 are such that while the given flexible reflective member 20 extends is longitudinally within channel 15, it is deflected to maintain a substantially semi-circular, parabolic, or other such continuously concave contour therealong. When a longitudinally extended tubular lamp 60 is disposed adjacent the intermediate base of the resulting reflective surface concavity, then, the light generated by lamp 60 is effectively directed from lighting system 1 in a substantially wide angle illumination pattern, much in the manner disclosed in U.S. Pat. No. 5,509,223.

Preferably, fixture body assembly 10 is formed of a sheet metal or other such material of comparable properties known in the art. The material is preferably of sufficiently suitable strength, rigidity, and durability for the intended application. In addition, the material is preferably of such thickness that it may be bent to delineate the various portions 11-14, without undue compromise of its structural integrity.

Examples of such materials for fixture body assembly 10 include sheet aluminum having a thickness of approximately 1 mm to be sufficiently malleable to the desired shape yet sufficiently strong and rigid to thereafter maintain the shaped form. Other examples include cold rolled steel having a thickness of approximately 0.4 mm to similarly provide a combination of material properties sufficient for the intended application. Of course, depending on such factors as anticipated environmental conditions during use, expected service life, and availability of manufacturing resources, various other materials of various suitable thicknesses may be used in accordance with the present invention.

The selected sheet-like metal material employed in the embodiment shown is formed by a roll forming or other suitable metal processing technique known in the art. The exposed outer surfaces of fixture body assembly 10 are preferably either finished, or finished with an electrostatic, powder, or other such coating, the particular choice of finish not being important to the present invention.

In the embodiment shown, the properties and dimensions of flexible reflective member 20 are such that it may realize the deflection necessary for its reflective surface to describe the predetermined concavity, even with only certain of its portions actually bearing against fixture body assembly 10. Typically, member 20 may be adequately supported by the surface portions 13 and 14 retentively engaging just the flexible reflective member's lateral edge and central portions. It is normally not necessary for the laterally opposed inner side surfaces 13, then, to extend fully downward to inside base surface 14, unless the mechanical properties of the material employed, or other such factors prevailing in the given application, require as much for sufficient structural stability, strength, and the like. This yields savings not only in terms weight and material consumption, but also in terms of requisite manufacturing time and effort.

Thus, inner side surfaces 13 preferably extend from respective top surfaces 12 towards inside bottom surface 14 only partially downward—extending by sufficient amounts to provide stable support for the flexible reflective member's lateral edges portions. Preferably, each inner side surface 13 also extends sufficiently downward that the likelihood of a given lateral edge portion of flexible reflective member 20 sliding out of engagement therewith is minimized, if not altogether eliminated.

Flexible reflective member 20 may be formed of any suitable material known in the art to provide at least one mirror grade reflective surface. The actual choice of material composition and structural configuration for flexible reflective member 20 is not important to the invention, so long as member 20 is found to be sufficiently deflectable by the surrounding structure to attain the predetermined continuously arcuate reflective surface contour required for the intended application.

In an exemplary embodiment, a silver or aluminum vapor deposited polyester film, such as silver mylar, formed by vacuum coating or other processes known in the art may be suitably employed for reflective member 20. In another example, flexible reflective member 20 may be formed of an aluminum or other such suitable sheet metal material having a thickness of approximately 0.007-0.010 inch. A mirror grade anodized thin metallic aluminum sheet material formed by pressing or rolling is one example of such materials. Other examples of suitable materials for reflective member 20 include a polycarbonate film having a reflective coating formed by silver or aluminum deposition, or other processes known in the art.

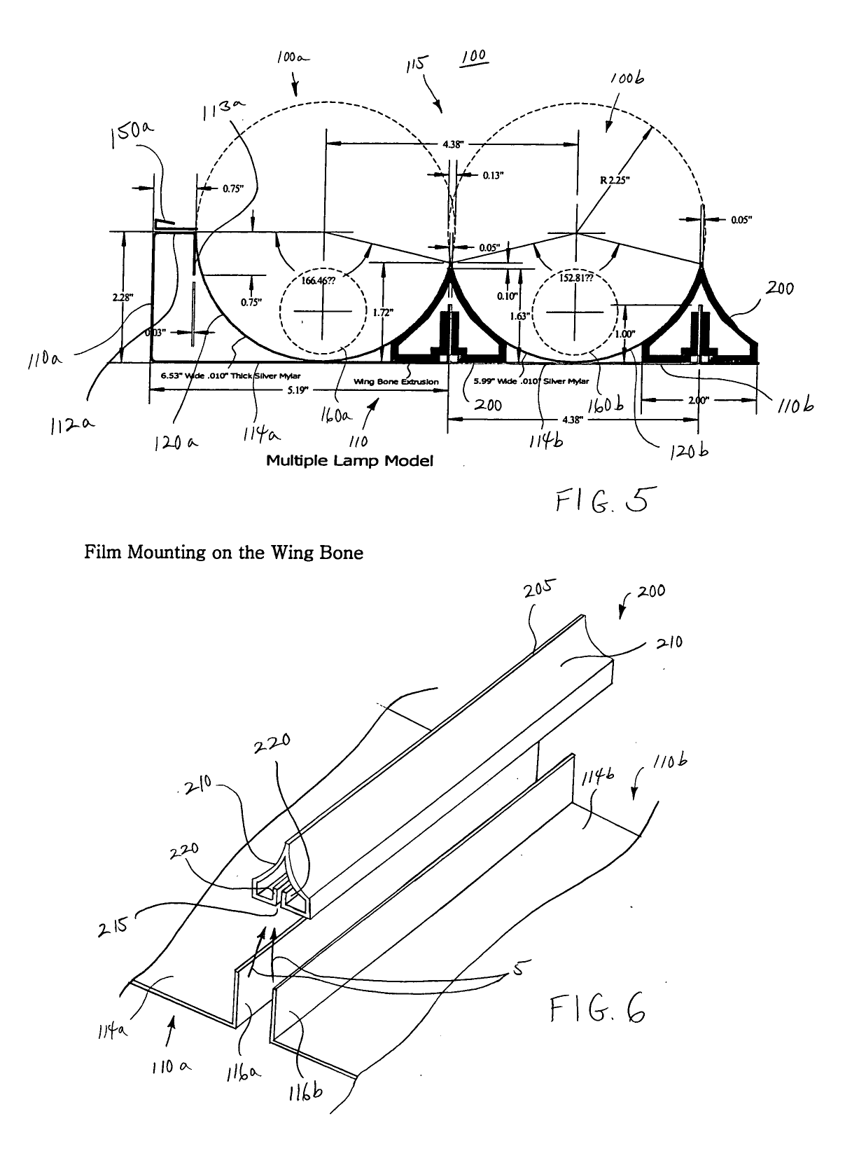

Flexible reflective member 20 is positioned within channel 15 to form, for example, a reflective concave surface having a substantially semi-circular sectional contour describing a predetermined diameter. Given an example wherein the reflective surface describes a diameter of approximately 4.5 inches, a corresponding width dimension is defined between points A and B (FIG. 4(a)), and a depth dimension of about 2.25 inches is defined from the top surfaces 12 to the inside base surface 14 of fixture body assembly 10. In that example, a silver or aluminum vapor deposited polyester film, such as silver mylar, of approximately 0.014 inch in thickness may be employed to obtain such substantially-circular reflective surface about tubular light source 60.

A suitable light source 60 in such exemplary configuration may be, for instance, a T-12 type lamp having a diameter of approximately 1.5 inches. Where a lamp of another type and/or configuration is employed, it may be preferable to suitably adapt certain dimensions accordingly. For example, where a T-10 type lamp having a diameter of approximately 1.0 inch is employed, a reflective surface diameter of approximately 3.0 inches and a depth dimension of about 1.5 inches from the top surfaces 12 to the inside base surface 14 of fixture body assembly 10 may be preferable. Such dimensional variations may be suitably made in accordance with the present invention, depending on the particular requirements of the intended application.

In accordance with the present invention, flexible reflective member 20, in its undeflected state, simply forms a flat, substantially planar sheet structure. No pre-forming, pre-shaping, or pre-mounting to a shaped backing, or other such extraneous steps are necessary prior to assembly of lighting system 1. Rather, flexible reflective member 20 is deflected to semi-rolled configuration and either slid longitudinally into channel 15 (if face assembly 5 is already coupled to fixture body assembly 10), else simply dropped therein prior to the face assembly's coupling to the top of fixture body assembly 10.

However it may have been placed in position, the resilient bias of flexible reflective member 20 when subjected to such deflection causes member 20 to press against the inner side surfaces 13 and the inside base surface 14 respectively at points A, B, and C, as illustrated in FIG. 4(a). It curvilinearly assumes and maintains the arcuate sectional contour shown, its lateral edges being stopped against those portions of face assembly 5 extending laterally beyond the inner side surfaces 13, and partially over channel 15 of fixture body assembly 10. Although it may not actually be fastened to any portion of either face assembly 5 or fixture body assembly 10, flexible reflective member 20 remains defectively captured by the surrounding structure.

As shown in FIGS. 4(a)-4(c), face assembly 5 is formed in the exemplary embodiment shown by a pair of slide-in guides 50 respectively disposed on top surfaces 12 of fixture body assembly 10. Each slide-in guide 50 forms a substantially J-shaped, track-like slot for slideably receiving an edge portion of a face panel member 70. Preferably, at least a portion of each slide-in guide 50 overlaps its corresponding top surface 12 to extend laterally into channel 15 and thereby form an edge stop structure for flexible reflective member 20 defectively retained within that channel 15.

Each slide-in guide 50 may be formed of any material known in the art suitable for the requirements of the intended application. For example, an extruded plastic material, such as an easily glueable polymeric material, of sufficient strength and rigidity to provide stable support for the given face panel member 70 may be used. Such other materials like cold rolled steel, aluminum, or other sheet metal materials may also be used. In certain embodiments, slide-in guides 50 may simply be formed as an integral part of fixture body assembly 10 itself. In certain other embodiments, protrusive members may be separately formed, apart from slide-in guides 50, to serve the flexible member stopping function.

Preferably, though not necessarily, each slide-in guide 50 in the embodiment shown is adhesively attached to a corresponding top surface 12 for simplicity and economy. Where the requirements of the intended application permit, pressure sensitive tape may be employed for this purpose. In other embodiments, each slide-in guide 50 may be fastened by other suitable means to a top surface 12, or another readily accessible part of fixture body assembly 10.

At least a portion of face panel member 70 defines a light transmissive portion 72 for face assembly 5. This light transmissive portion 72 extends over channel 15 to transmit the light emitted from light source 60 and reflected by the reflective surface of flexible reflective member 20.

While the various components of face assembly 5 are shown to be discretely formed and coupled to fixture body assembly 10, some or all of those components may be formed as integral parts of fixture body assembly 10. As mentioned, for instance, one or both of the slide-in guides 50 and the stop edge portions they form may be realized in alternate embodiments as suitable integrally formed extensions of fixture body assembly 10. Extrusion or other such suitable processes known in the art may be employed to form the integrally combined structures in those alternate embodiments.

Lighting system 1 in the disclosed embodiment further includes a pair of end plates 40 which serve to cap the otherwise openly exposed longitudinal ends of fixture body assembly 10. End plates 40 thereby enclose channel 15. They also serve to respectively support a pair of lamp holders 42 between which a tubular lamp 60 is held to longitudinally extend along channel 15 of fixture body assembly 10. Each end plate 40 preferably supports a lamp holder 42 is affixed thereto by suitable fasteners 41, and is preferably affixed to fixture body assembly 10 by suitably mated fasteners 44 through corresponding holes 43 as shown. Any suitable fastening means known in the art may be employed in these respects. For instance, adhesive or simply a mechanically interlocked engagement may be employed in place of the fastener elements illustrated.

End plates 40 are thus easily removable from fixture body assembly 10 to provide convenient open access to channel 15 and the flexible reflective member 20 retained therein. Such flexible reflective member 20 may be easily, removed or replaced by sliding longitudinally outward or inward relative to channel 15. When they are in place, end plates 40 prevent the escape of flexible reflective member 20 which is retained in unfastened, though deflected, manner within channel 15.

End plates 40 may too be formed of any suitable material known in the art. Examples of such suitable materials include press-formed sheet metal, injection molded plastic, and various other such materials, the specific choice of which is not important to the present invention. Lamp holders 42 supported on end plates 40 may be of any suitable type of ample safety rating commercially available.

The structural configuration of the fixture body assembly 10 components defining channel 15 and the elasticity and thickness of reflective member 20 are such that when reflective member 20 is retained within channel 15, it is deflected to preferably form a quadratically described surface contour. The precise sectional contour imparted to the flexible reflective member 20 may then be determined by appropriately setting these structural and material parameters and freely inserting a normally flat sheet member 20 into the retentive confines of the fixture body assembly's channel 15.

The concave arcuate reflective surface formed by the flexible reflective member's deflection when so confined within this channel 15 may be of any suitable sectional contour required by the intended application. For example, flexible reflective member 20 may be deflected to form a reflective surface having a continuous, semi-circular sectional contour sufficient to cause reflected components of light energy emitted by the tubular light source 60 to constructively intersect one another as they pass through the light transmissive portion 72 of face panel member 70.

The net effect to an observer outside face panel member 70 is an expanded lighting band illuminated about as brightly as the surface of the tubular light source 60 itself, much as described in U.S. Pat. No. 5,509,223. Graphic designs or other indicia formed on the light transmissive portion 72 of face panel member 70 are then be strikingly illuminated and thereby visually enhanced by this bright illumination effect.

Where the structural configuration of the fixture body assembly 10 components defining channel 15 and the elasticity and thickness of reflective member 20 are such that when reflective member 20 is retained within channel 15, it is deflected to alternatively form, for example, a parabolic reflective surface (such as, by varying relative dimensions between points A, B, and C illustrated in FIG. 4(a)), the reflected, or virtual image, components emanating from such reflective surface combine with one another in a different manner. Typically, what results at the light transmissive portion 72 in that event is a less uniformly illuminated lighting band having one or more dark areas interposed between bright areas. The light transmissive portion 72 of face panel member 70 may then be provided with a suitable diffusing structure known in the art, such as: convex diamond or convex line pattern formations, a frosted or whitened diffuser face, and the like.

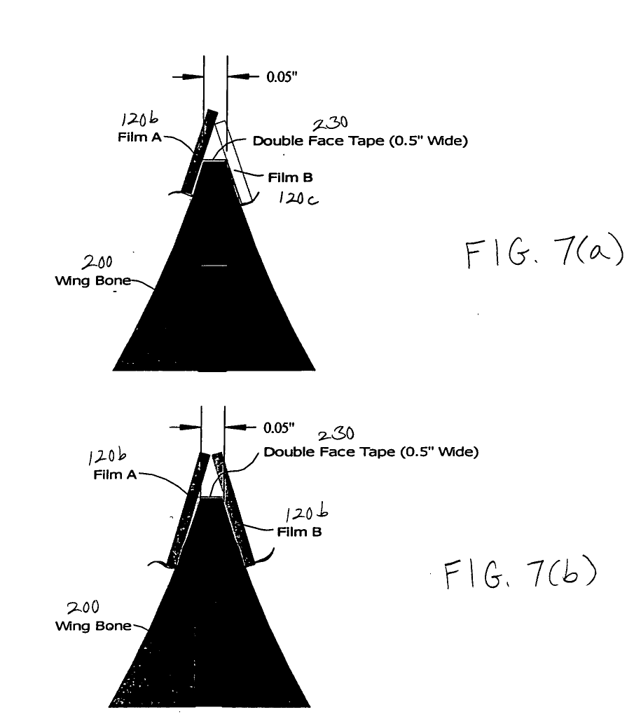

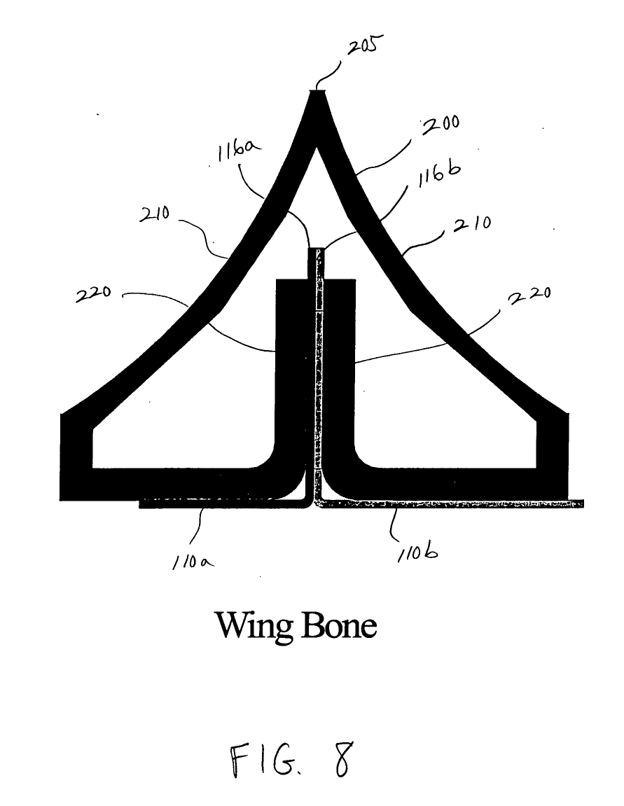

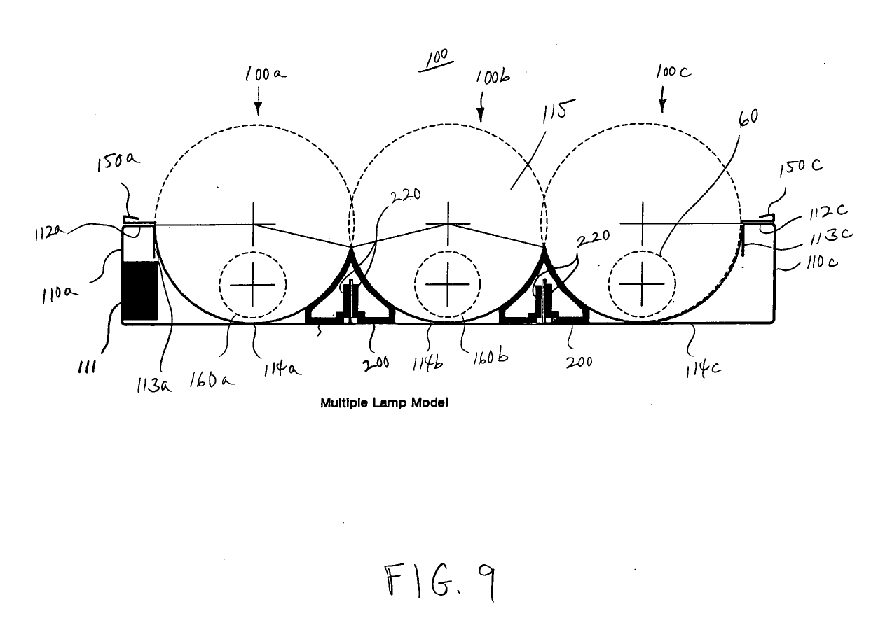

Referring now to FIGS. 5-9, there is shown an alternate embodiment of the present invention, wherein lighting system 100 includes a plurality of combined lighting modules 100a, 100b, and 100c powered by one or more ballasts 111. The modules 100a-100c are arranged laterally in series, with each adjacent pair of modules 100a-100c being securely joined by a wing bone member 200 extending therebetween. While three lighting modules 100a-100c are shown in the illustrated embodiment, any suitable number of such modules 100a-100c may be combined to the extent that the structural properties of the various system components and the requirements of the intended application permit.

In accordance with the present invention, these lighting modules include at least a pair of end modules 100a, 100c which may themselves be directly paired by a wing bone member 200. These end modules 100a, 100c in the embodiment shown flank one or more intermediate modules 100b disposed therebetween to expand the overall lighting area of the resulting system 100. Such modularity of structure provides optimum flexibility; however, the lighting system 100 collectively formed by these modules 100a-100c may in other embodiments be formed as a single unit. A collective fixture body assembly 110 would then be of unitary structure, with one or more wing bone member 200 simply serving intermediate support functions for the given reflective surfaces, and not necessarily any module-joining function.

As shown in FIGS. 5 and 9, a fixture body assembly 110 is collectively formed in the embodiment shown by modular sections 110a, 110b, and 110c. This fixture body assembly 110 is collectively defined thereby to include a pair of laterally opposed inner side surfaces 113a, 113b between which extends a base surface formed collectively by the respective modular sections' inside base surface portions 114a, 114b, 114c. These surfaces 113a, 113c and 114a, 114b, 114c collectively define a longitudinally extended channel 115 within which a plurality of flexible reflective members 120a, 120b, 120c are retained to define appropriately contoured reflective surfaces for respective light sources 160a, 160b, 160c. Depending on the number of lighting sections employed in a given embodiment, one or more wing bone members 200 are intermediately disposed within channel 115, preferably along the joints of adjacent modular sections 110a, 110b, 110c to deflectively support portions of adjacent reflective member pairs.

Each of the modular sections 110a, 110b, 110c is preferably formed in much the same manner as fixture body assembly 10 of the embodiment shown in FIGS. 1-4(c) and described in preceding paragraphs. To accommodate the expanded configuration of lighting system 100 in the present embodiment, however, each end section 110a, 110c is preferably formed as shown, defining one inner side surface 113a, 113c to extend transversely downward from a corresponding top surface 112a, 112c. The opposite lateral, or inner, end of each modular end section 110a, 110c preferably terminates at a joint panel portion 116a, 116c extending transversely upward from the section's base surface portion 114a, 114c.

In certain embodiments, such modular end sections 110a and 110b may themselves be directly joined by a single wing bone member 200; however, in the illustrated embodiment, one or more intermediate modular sections 110b is disposed between the two end sections 110a, 110c. Each intermediate modular section 110b is preferably formed with a substantially U-shaped sectional contour, and includes a longitudinally extended base surface portion 114b preferably corresponding in its various dimensions to those of the modular end sections 110a, 110c. Intermediate section 110b also includes a pair of joint panel portions 116b extending transversely upward from each lateral edge of its base surface portion 114b, so as to correspond respectively with the base panel portions 116a, 116c of the adjacent modular end sections 110a, 110c. Where more than one intermediate section 110b is employed, at least one lateral side's joint panel portion 116b joins with a corresponding joint panel portion 116b of the additional intermediate section 110b adjacent thereto.

Referring now to FIG. 6, adjacent pairs of modular sections 110a, 100b are shown, joined by bringing together their nearest joint panel portions 116a-116b to bear against one another, and to engage one or more wing bone members 200. Each wing bone member 200 is preferably configured as shown with a pair of inner flaps 220 spaced to define therebetween a longitudinal slot 215 which receives the joint panel portions 160a-160b paired, as illustrated in each of the FIGS. 5, 8, and 9. One wing bone member 200 may extend substantially the entire longitudinal length of the joint between modular sections as in the illustrated embodiment. Alternatively, a plurality of wing bone members 200 of shorter longitudinal length may be employed to extend along and collectively cover the entire length of the longitudinal joint between adjacent sections 110a-110c, or certain portions thereof. Factors such as the thickness and rigidity of the reflective members 120a-120c to be retentively supported will bear on the choice of actual structural configuration in this regard.

In practice, it may be necessary to spot weld or otherwise fasten the joined joint panel portions 116a-116b in order to better secure the resulting structure once the modules are configured for the desired application. Similar means may be utilized to further secure a given wing bone member 200 with the modular sections 110a-10c that it is joining. Preferably, each wing bone member's inner flaps 220 form a spring-like clasping structure for the paired joint panel portions 116a-116c passed in press-fit manner between them. The opposed inner flaps 220 then resiliently bear inward against the outer sides of the joint panel portion pair to reinforce both the joint and the wing bone member's engagement thereof.

Each wing bone member 200 is preferably formed with a pair of cupped surfaces 210 extending arcuately downward from opposing sides of an apex portion 205. Each cupped surface 210 defines a curvature corresponding to the predetermined quadratic curvature that each flexible reflective member 120a-120c is deflected to attain when assembled within system 100, much as described in preceding paragraphs for the embodiment of FIGS. 1-4(c). Each cupped surface 210 thus provides a support surface against which a given reflective member 120a-120c will nest in substantially flush, conformed manner when deflected for assembly within system 100.

As illustrated in FIGS. 7(a)-7(b), the portions of those reflective members 120a-120c supported by a wing bone member 200 is preferably secured by a double face tape adhesive or other suitable means to at least a portion of the underlying cupped surface 210 and/or the apex portion 205. Such securement obviates the need for extraneous structures for retaining a lateral end of the given flexible member 120a-120c. In the case of an intermediate modular section 110b, both lateral free ends of reflective member 120b are thus secured to the two wing bone members 200 supporting it. In the case of an end modular section 110a, 110c, the free lateral end at an outer side of the given flexible reflective member 120a, 120c is stopped against a corresponding slide-in guide 150a, 150c disposed to overlap the given top surface 112a, 112c, much as described in preceding paragraphs for the embodiment of FIGS. 1-4(c). Again, the resilient bias of flexible reflective member 120a, 120c is such that, when kept deflected, its outer lateral end may be sufficiently retained by this stopping engagement, so long as the other of its lateral ends remains adequately supported and secured to a wing bone member 200 as described above.

The respective free lateral ends of adjacent reflective members 120a-120c may be disposed one relative to the other in any suitable manner required to maintain the uniformity of each modular section's reflective surface contour. In the case illustrated in FIG. 7(a), for example, an edge of reflective member 120b slightly overlaps an adjacent edge of reflective member 120c. This may result from an end section's reflective member 120c having to extend slightly farther to bear against the stopping protrusion formed by slide-in guide 150c at an end section's outer side. In the case of a wing bone member 200 serving two adjacent intermediate modular sections 110b, the two sections' reflective members 120b are similarly if not identically situated. As illustrated in FIG. 7(b), then, the sections' adjacent lateral edges converge more evenly at the given wing bone member's apex 205. The relative disposition of such reflective member edge portions converging at a given wing bone member 200 is not particularly important to the present invention. It is important only to the extent that the convergence is accommodated without causing undue interference between reflective members 120a-120c or undue contortion of either member's reflective surface.

Each wing bone member 200 is preferably, though not necessarily, formed with a unitary structure. It may be formed of such materials as plastic or aluminum extruded to a predetermined configuration, as illustrated in FIGS. 5-9. In accordance with the present invention, each wing bone member 200 is dimensioned and positioned such that its cupped surfaces 210 concurrently support two adjacent reflective members 120a-120c, such that each of those reflective members 120a-120c maintains its deflected semi-circular, parabolic, or other predetermined arcuate contour, as described in preceding paragraphs. Moreover, each wing bone member 200 is of sufficient strength, rigidity, and durability to provide consistency of support throughout the service life of the resulting system 100, and to withstand all expected environmental conditions without loss of structural integrity.

As in the preceding embodiment of FIGS. 1-4(c), one or more face panel members (not shown) may be inserted across the channel 115, slideably guided and retained by opposing slide-in guide members 150a, 150c. The face panel member would then transmit the wide angle light collectively emitted from lighting modules 100a-100c. Suitable measures for diffusing that portion of the light emitted from one or more of the lighting modules 100a-100c may be applied to face panel member, where necessary. In this regard, diffusing structures known in the art like convex diamond or convex line pattern formations, a frosted or whitened diffuser faces, and others may be provided on one or more light transmissive portions of the face panel member.

Although this invention has been described in connection with specific forms and embodiments thereof, it will be appreciated that various modifications other than those discussed above may be resorted to without departing from the spirit or scope of the invention. For example, equivalent elements may be substituted for those specifically shown or described, certain features may be used independently of other features, certain features may be formed of components other than those described, and in certain of the process method steps described, particular steps may be reversed or interposed, all without departing from the spirit or scope of the invention as defined in the appended claims.

1. A lighting system comprising:
(a) a fixture body assembly including a longitudinally extended base surface and at least a pair of laterally opposed inner side surfaces transversely oriented relative to said base surface, said inner side and base surfaces defining a longitudinally extended channel;
(b) a face assembly coupled to said fixture body assembly to extend at least partially over said channel thereof, said face assembly including a light transmissive portion;
(c) at least one wing bone member disposed in said channel of said fixture body assembly, said wing bone member having a pair of cupped surfaces extending arcuately downward from opposing sides of an apex portion;
(d) a plurality of flexible reflective members disposed in said channel, a pair of said reflective members each being defectively retained between one said cupped surface of said wing bone member and one said inner side surface of said fixture body assembly to define a reflective surface concavely arcuate in sectional contour; and,
(e) at least a pair of light sources each disposed adjacent said base portion of one said reflective surface, whereby light collectively emitted by said light sources is directed in a substantially wide angle illumination pattern through said light transmissive portion of said face assembly.

2. The lighting system as recited in claim 1 wherein said reflective surface defined by said flexible reflective member is substantially semi-circular in sectional contour.

3. The lighting system as recited in claim 1 wherein each said flexible reflective member is attached to one said cupped surface of said wing bone member.

4. The lighting system as recited in claim 1 wherein said fixture body assembly includes at least a pair of top surfaces extending laterally outward from said inner side surfaces to support said slide-in guides, said face assembly including a pair of slide-in guides overlapping said respective top surfaces to extend into said channel and thereby form edge stops for respective ones of said flexible reflective member.

5. The lighting system as recited in claim 1 wherein said fixture body assembly includes a plurality of modular sections joined by at least one said wing bone member to collectively define said channel, said modular sections having said flexible reflective members disposed respectively therein.

6. The lighting system as recited in claim 5 wherein said modular sections each include at least one base panel portion and a joint panel portion extending transversely upward therefrom, said wing bone member engaging said joint panel portions of adjacent ones of said modular sections, whereby said base panel portions of said adjacent modular sections collectively form said base surface of said fixture body assembly.

7. The lighting system as recited in claim 6 wherein said modular sections include at least first and second end sections respectively defining said inner side surfaces.

8. The lighting system as recited in claim 7 wherein said modular sections include at least one intermediate section disposed between said first and second end sections, said intermediate section including a laterally opposed pair of said joint panel portions projecting transversely upward from said base panel portion extending therebetween.

9. The lighting system as recited in claim 7 wherein each said modular section is integrally formed.

10. The lighting system as recited in claim 6 wherein each said wing bone member includes a bottom portion extending from said cupped surfaces to define a receptacle slot for retentively receiving said joint panel portions of said adjacent modular sections joined thereby.

11. The lighting system as recited in claim 5 wherein at least one pair of said modular sections is joined by a plurality of said wing bone members spaced one from the other in longitudinally aligned manner.

12. The lighting system as recited in claim 1 wherein said reflective surface defined by said flexible reflective member is substantially parabolic in sectional contour, said light transmissive portion of said face assembly having a light diffusing structure formed thereon.

13. A lighting system comprising:
(a) a fixture body assembly including a longitudinally extended base surface and at least a pair of laterally opposed inner side surfaces transversely oriented relative to said base surface, said inner side and base surfaces defining a longitudinally extended channel;
(b) a face assembly coupled to said fixture body assembly to extend at least partially over said channel thereof, said face assembly including a removable face panel member defining a light transmissive portion over said channel of said fixture body assembly;
(c) at least one wing bone member disposed in said channel of said fixture body assembly, said wing bone member having a pair of cupped surfaces extending arcuately downward from opposing sides of an apex portion;
(d) a plurality of flexible reflective members disposed in said channel, a pair of said reflective members each being defectively retained between one said cupped surface of said wing bone member and one said inner side surface of said fixture body assembly to define a concave reflective surface substantially semi-circular in sectional contour; and,
(e) at least a pair of light sources each disposed adjacent said base portion of one said reflective surface, whereby light emitted by said light source is directed in a substantially wide angle illumination pattern through said light transmissive portion of said face assembly.

14. The lighting system as recited in claim 13 wherein said face assembly includes at least a pair of slide-in guides disposed on said fixture body assembly for slidably receiving said face panel member therebetween, each said slide-in guide defining a longitudinally extended slot for slidably receiving an edge of said face panel member.

15. The lighting system as recited in claim 13 wherein each said flexible reflective member is adhesively attached to one said cupped surface of said wing bone member.

16. The lighting system as recited in claim 13 wherein said fixture body assembly includes a plurality of modular sections having said flexible reflective members disposed respectively therein, said modular sections being joined by at least one said wing bone member to collectively define said channel, said modular sections each including at least one base panel portion and a joint panel portion extending transversely upward therefrom, each said wing bone member engaging said joint panel portions of adjacent ones of said modular sections, whereby said base panel portions of said adjacent modular sections collectively form said base surface of said fixture body assembly.

17. The lighting system as recited in claim 16 wherein said modular sections include at least first and second end sections respectively defining said inner side surfaces, and at least one intermediate section disposed between said first and second end sections, said intermediate section having a laterally opposed pair of said joint panel portions projecting transversely upward from said base panel portion extending therebetween.

18. The lighting system as recited in claim 16 wherein each said wing bone member is integrally formed with a bottom portion extending from said cupped surfaces to define a receptacle slot for retentively receiving said joint panel portions of said adjacent modular sections joined thereby.

19. The lighting system as recited in claim 16 wherein at least one pair of said modular sections is joined by a plurality of said wing bone members spaced one from the other in longitudinally aligned manner.

20. A lighting system comprising:
(a) a fixture body assembly including a plurality of modular sections collectively forming a longitudinally extended base surface and at least a pair of laterally opposed inner side surfaces transversely oriented relative to said base surface, said inner side and base surfaces defining a longitudinally extended channel, said modular sections each including at least one base panel portion and a joint panel portion extending transversely upward therefrom;
(b) a face assembly coupled to said fixture body assembly to extend at least partially over said channel thereof, said face assembly including a removable face panel member defining a light transmissive portion over said channel of said fixture body assembly;
(c) at least one wing bone member engaging said joint panel portions of adjacent ones of said modular sections to join said adjacent modular sections together, each said wing bone member having a pair of cupped surfaces extending arcuately downward from opposing sides of an apex portion, said base panel portions of said adjacent modular sections being joined by said wing bone member to collectively form said base surface of said fixture body assembly;
(d) a plurality of flexible reflective members each disposed in one said modular section, a pair of said reflective members each being deflectively retained between one said cupped surface of said wing bone member and one said inner side surface of said fixture body assembly to define a concave reflective surface substantially semi-circular in sectional contour, said reflective member being adhesively attached in substantially conforming manner to said cupped surface; and,
(e) at least a pair of light sources each disposed adjacent said base portion of one said reflective surface, whereby light emitted by said light source is directed in a substantially wide angle illumination pattern through said light transmissive portion of said face assembly.
